(19) United States
(12) Patent Application Publication
(10) Pub. No.: US 2025/0145201 A1
(43) Pub. Date: May 8, 2025

(54) HAND-DRIVING MOVABLE BODY

(71) Applicant: Toshiba Tec Kabushiki Kaisha, Tokyo (JP)

(72) Inventor: Takahiro KOGOSHI, Sunto Shizuoka (JP)

(21) Appl. No.: 18/910,961

(22) Filed: Oct. 9, 2024

(30) Foreign Application Priority Data
Nov. 2, 2023 (JP) 2023-188868

(51) Int. Cl. B62B 3/12; B62B 3/14; H01R 13/62; H01R 13/631; H01R 13/703; H01R 13/74

(52) U.S. Cl. CPC B62B 3/12; H01R 13/6315; H01R 13/748; B62B 3/1424; H01R 13/6205; H01R 13/703; H01R 2201/26

(57) ABSTRACT

A hand-driving movable body according to an embodiment includes a base, a first connector, and a support portion. The first connector has a terminal and is coupled by fitting with an external connector that moves in a first direction relative to the terminal. The support portion supports the terminal so as to be movable with respect to the base in a first direction and a direction intersecting the first direction.

### CROSS-REFERENCE TO RELATED APPLICATIONS

This application is based upon and claims the benefit of priority from Japanese Patent Application No. 2023-188868, filed Nov. 2, 2023, the entire contents of which are incorporated herein by reference.

### FIELD

Embodiments described herein relate generally to a hand-driving movable body.

### BACKGROUND

Conventionally, there has been proposed a shopping cart in which a product registration device is mounted on the shopping cart so that a customer can register a product to be purchased by the customer himself/herself while shopping in a store. Such a shopping cart is moved to a power supply unit, for example, and charges a battery for operating the product registration device (for example, JP 2023-102931 A).

During charging of such a shopping cart, the charging connector of the shopping cart and the charging connector of the power supply unit are coupled. Therefore, if the shopping cart is moved, a terminal of the charging connector may be damaged.

An object of the present invention is to suppress breakage of a terminal of a connector of a hand-driving movable body in a state where an external connector is coupled to the connector of the hand-driving movable body.

### BRIEF DESCRIPTION OF THE DRAWINGS

FIG. 1 is a first perspective view of a shopping cart according to an embodiment;

FIG. 2 is a second perspective view of the shopping cart according to the embodiment;

FIG. 3 is a view illustrating a state in which a battery is being charged with the shopping carts of the embodiment stacked;

FIG. 4 is a hardware block diagram illustrating an example of a hardware configuration of the shopping cart according to the embodiment;

FIG. 5 is a view illustrating a configuration of a main part of an output connector included in the shopping cart according to the embodiment;

FIG. 6 is a perspective view illustrating a detailed structure of the output connector;

FIG. 7 is a view illustrating a configuration of a main part of an input connector included in the shopping cart according to the embodiment;

FIG. 8 is a perspective view illustrating a detailed structure of the input connector;

FIG. 9 is a view for explaining a magnet attached to the output connector cover;

FIG. 10 is a first diagram illustrating a state in which the input connector is inserted into the output connector;

FIG. 11 is a second diagram illustrating a state in which the input connector is inserted into the output connector;

FIG. 12 is a third diagram illustrating a state in which the input connector is inserted into the output connector;

FIG. 13 is a cross-sectional view of a portion including the input connector in the shopping cart according to the embodiment;

FIG. 14 is a perspective view of a portion including the input connector in the shopping cart according to the embodiment;

FIG. 15 is a perspective view of the input connector in the shopping cart according to the embodiment;

FIG. 16 is a block diagram illustrating an example of a functional configuration of an energization control circuit included in the shopping cart according to the embodiment;

FIG. 17 is a perspective view illustrating a state in which the power supply unit of the embodiment and the shopping cart are coupled;

FIG. 18 is a perspective view of the power supply unit according to the embodiment;

FIG. 19 is a cross-sectional view of a portion including a first guide portion in the power supply unit of the embodiment and a portion including a guided portion in the shopping cart, illustrating a state in which an output connector of the power supply unit and an input connector of the shopping cart are separated from each other;

FIG. 20 is a cross-sectional view of a portion including a second guide portion in the power supply unit of the embodiment and a portion including the input connector in the shopping cart, illustrating a state in which the output connector of the power supply unit and the input connector of the shopping cart are separated from each other;

FIG. 21 is a cross-sectional view of a portion including a first guide portion in the power supply unit of the embodiment and a portion including a guided portion in the shopping cart, illustrating a state in which an output connector of the power supply unit and an input connector of the shopping cart are coupled;

FIG. 22 is a cross-sectional view of a portion including the second guide portion in the power supply unit of the embodiment and a portion including the input connector in the shopping cart, illustrating a state in which the output connector of the power supply unit and the input connector of the shopping cart are coupled; and

FIG. 23 is a view illustrating a relationship between a first guide portion and a guided portion according to the embodiment.

### DETAILED DESCRIPTION

Hereinafter, embodiments will be described in detail with reference to the drawings. Note that the present invention is not limited by the embodiments described below.

Hereinafter, a shopping cart 10, a power supply unit 5, and a guide device 600 according to embodiments of the present disclosure will be described with reference to the drawings.

### Schematic Configuration of Shopping Cart

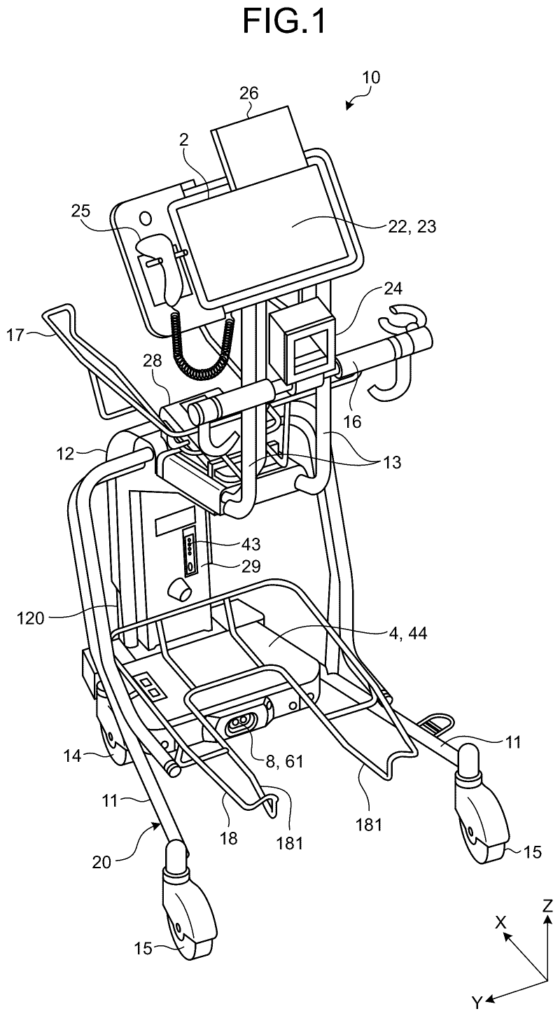

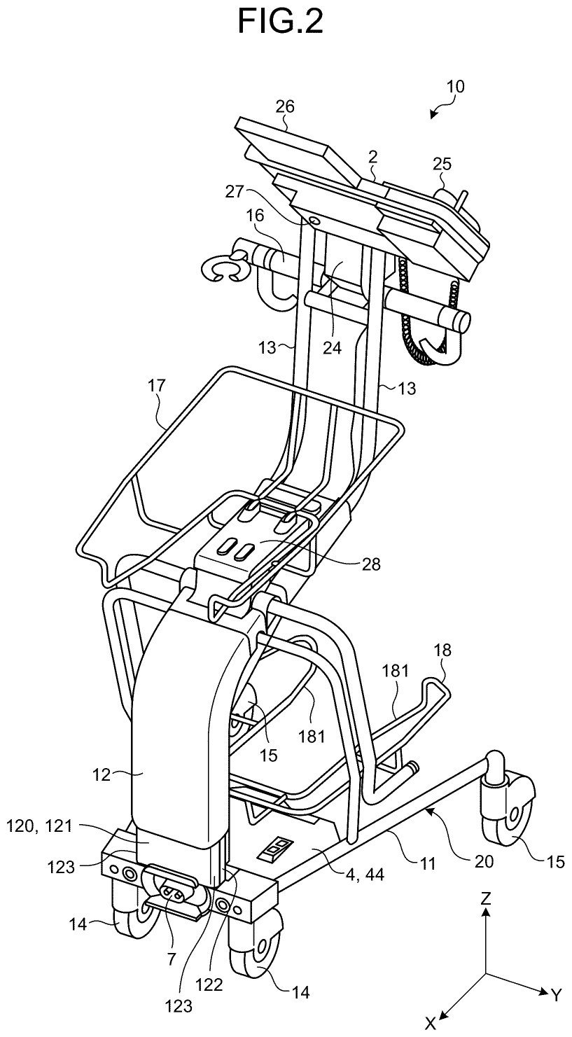

A schematic configuration of the shopping cart 10 of the embodiment will be described with reference to FIGS. 1 and 2. FIG. 1 is a first perspective view of a shopping cart according to the embodiment. FIG. 2 is a second perspective view of the shopping cart according to the embodiment.

The shopping cart 10 reads product information of a product that a customer wants to purchase while pushing and walking in a store, and registers the product. The customer holds the registered product in the basket and continues shopping. After the shopping is finished, the customer goes to an accounting machine (not illustrated) and causes the accounting machine to perform a settlement processing related to the registered product. Note that the shopping cart 10 itself may have a function of performing settlement processing. The shopping cart 10 is an example of a hand-driving movable body.

In the present specification, an XYZ coordinate system including an X axis, a Y axis, and a Z axis is defined for convenience. The XYZ coordinate system is provided for the shopping cart 10. The X axis, the Y axis, and the Z axis are orthogonal to each other. The X axis is provided along the front-rear direction of the shopping cart 10. The Y axis is provided along the width direction (left-right direction) of the shopping cart 10. The Z axis is provided along the up-down direction of the shopping cart 10.

Further, in the present specification, an X direction, a Y direction, and a Z direction are defined. The X direction is a direction along the X axis and includes a +X direction indicated by an arrow of the X axis and a −X direction which is an opposite direction of the arrow of the X axis. The Y direction is a direction along the Y axis, and includes a +Y direction indicated by an arrow of the Y axis and a −Y direction which is an opposite direction of the arrow of the Y axis. The Z direction is a direction along the Z axis and includes a +Z direction indicated by an arrow of the Z axis and a −Z direction which is an opposite direction of the arrow of the Z axis.

In addition, the +Z direction is the same as the upward direction in the vertical direction, and the −Z direction is the same as the downward direction in the vertical direction.

The shopping cart 10 includes a frame 20, a pair of front wheels 14, and a pair of rear wheels 15. The frame 20 includes a pair of left and right bottom frames 11, a lower frame 12, and an upper frame 13. The pair of left and right bottom frames 11, the lower frame 12, and the upper frame 13 are coupled to each other. The pair of front wheels 14 and the pair of rear wheels 15 are attached to the bottom frame 11. The interval between the pair of front wheels 14 is narrower than the interval between the pair of rear wheels 15. The front wheel 14 and the rear wheel 15 are installed in the front-rear direction of the shopping cart 10. The front wheel 14 and the rear wheel 15 are attached to the bottom frame 11 by an attachment member (not illustrated). The front wheel 14 and the rear wheel 15 can be redirected to the left and right around the attachment position to the bottom frame 11. Therefore, the traveling direction of the shopping cart 10 can be changed to the right and left according to the force applied to a handle 16 installed above the shopping cart 10. That is, the direction of the shopping cart 10 can be changed. The customer grips the handle 16 and pushes and walks while changing the direction of the shopping cart 10 to the left and right. The handle 16 is a push portion that can be gripped and pushed by a customer (user). The frame 20 is an example of a base. The front wheel 14 and the rear wheel 15 are examples of wheels.

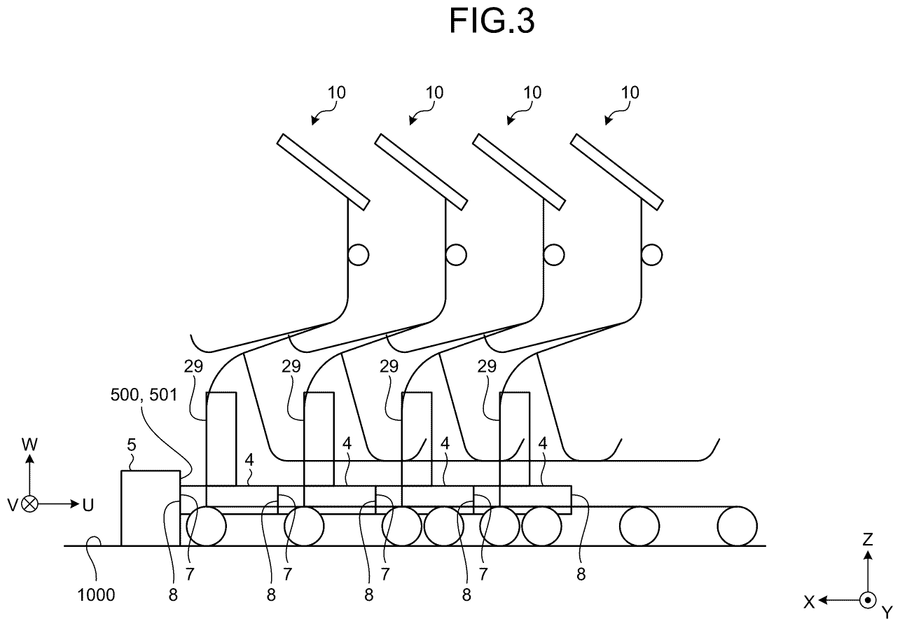

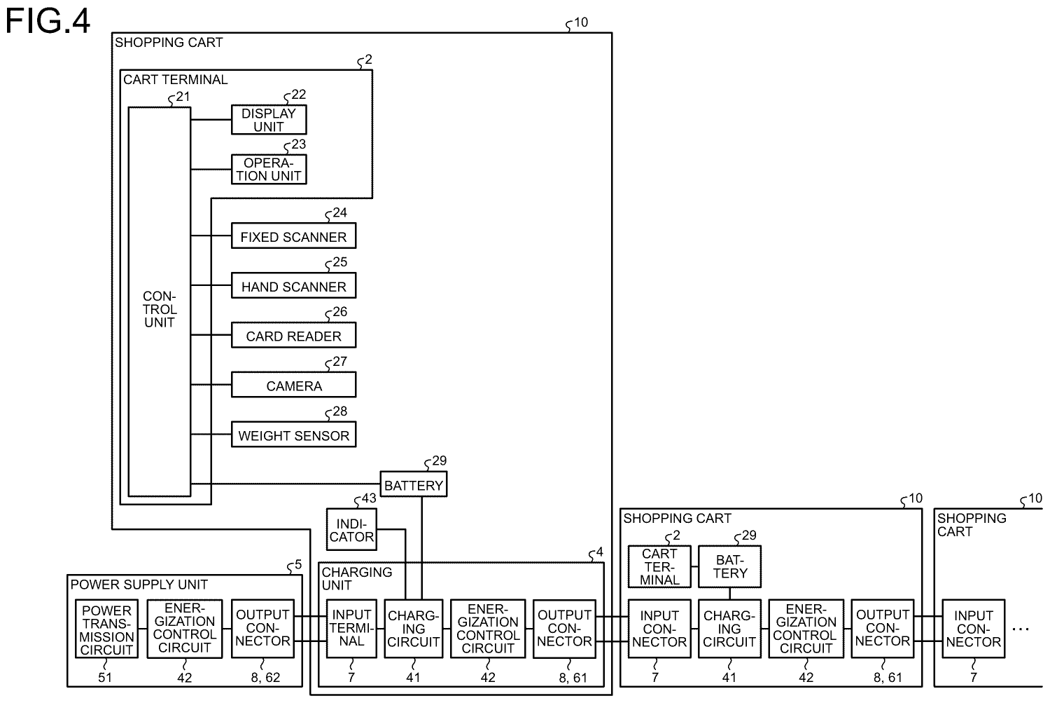

A charging unit 4 is attached between the pair of left and right bottom frames 11. The charging unit 4 includes a charging circuit 41 (see FIG. 4) built therein, and charges a battery 29 described later. A detailed charging method will be described later (see FIG. 3). In addition, the charging unit 4 includes an input connector 7 and an output connector 8. Note that the charging unit 4 also serves as a strength member that connects the left and right bottom frames 11.

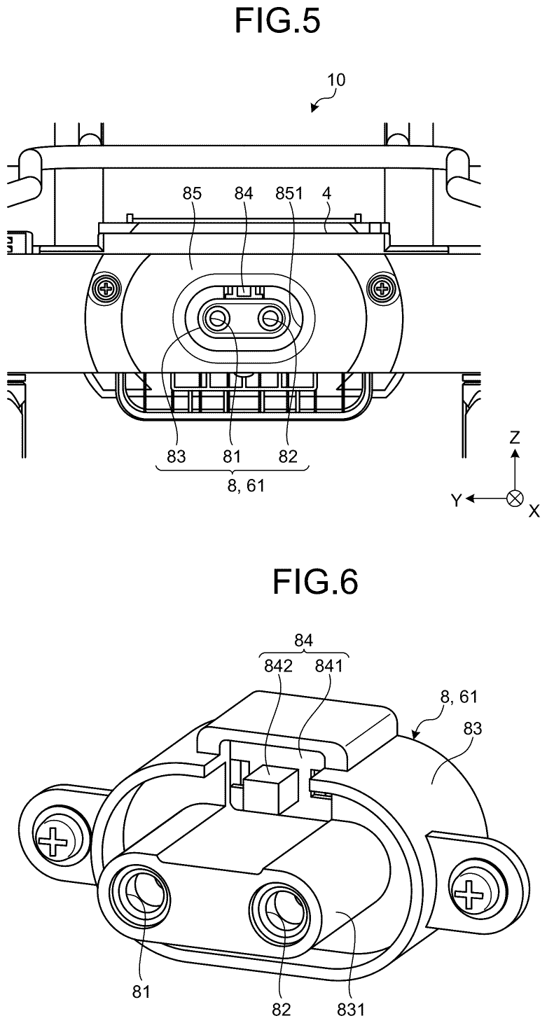

The input connector 7 is a charging connector connected to the power supply unit 5 (see FIG. 3). Power for charging the battery 29 is supplied from the power supply unit 5 to the input connector 7. Further, the input connector 7 is a charging connector connected to the output connector 8 of another shopping cart 10. Power for charging its own battery 29 is supplied to the input connector 7 from the output connector 8 of another shopping cart 10. Note that the input connector 7 and the output connector 8 are installed at the same height from the floor surface. The detailed structure of the input connector 7 will be described later in detail (see FIGS. 5 and 6).

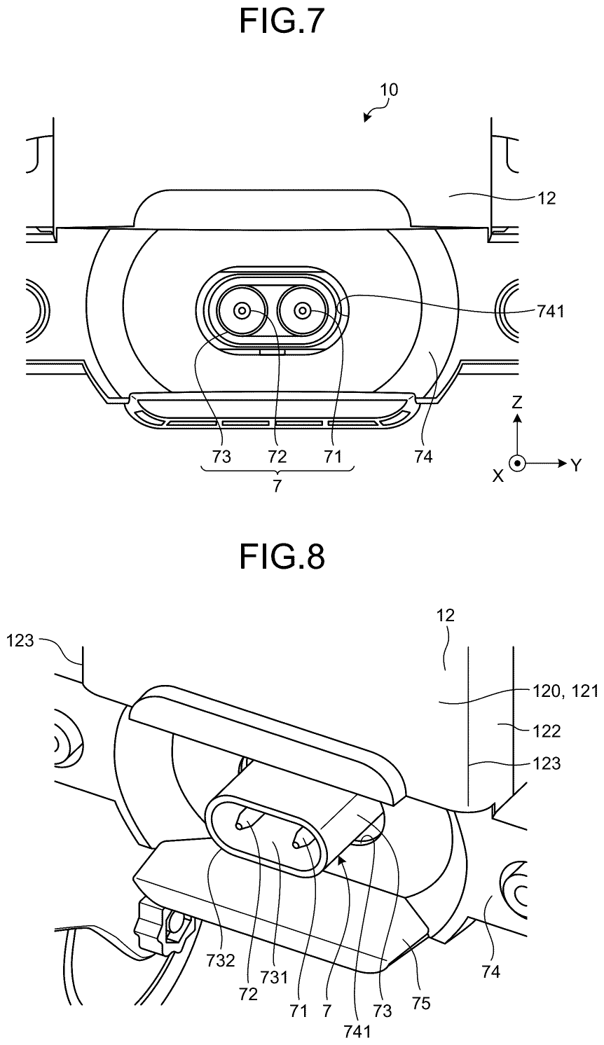

The output connector 8 is a charging connector connected to the input connector 7 of another shopping cart 10. The detailed structure of the output connector 8 will be described later in detail (see FIGS. 7, 8, etc.).

On the front side (+X direction side) of the bottom frame 11, the lower frame 12 rising upward (+Z direction side) and then extending obliquely forward and upward is attached. The lower frame 12 embraces the battery 29. The battery 29 is a rechargeable secondary battery that supplies power to various electronic devices included in the shopping cart 10. The battery 29 is, for example, a lithium ion battery, a nickel cadmium battery, a nickel hydrogen battery, a lead storage battery, or the like.

The pair of upper frames 13 is attached to the upper end of the lower frame 12 upward (+Z direction side). A bar-shaped handle 16 along the left-right direction (Y direction) of the shopping cart 10 is attached to the pair of upper frames 13. Various electronic devices included in the shopping cart 10 are attached to the upper frame 13 and the handle 16.

A lower basket receiving frame 18 is attached to the bottom frame 11 and the lower frame 12. A shopping basket (not illustrated) that accommodates a product when a customer performs shopping is placed on the lower basket receiving frame 18. The lower basket receiving frame 18 has a pair of left and right guide surfaces 181. The pair of guide surfaces 181 are provided to be separated from each other in the left-right direction (horizontal direction) of the shopping cart 10, and approach each other toward the output connector 8, that is, toward the front side (+X direction) of the shopping cart 10 in the front-rear direction. The pair of guide surfaces 181 come into contact with a guided portion 120 of the lower frame 12 at the subsequent stage shopping cart 10 that has entered between the pair of guide surfaces, thereby guiding (leading) the shopping cart 10 at the subsequent stage such that the input connector 7 of the shopping cart 10 at the subsequent stage faces an output connector 62. Details of the guided portion 120 of the lower frame 12 will be described later.

An upper basket receiving frame 17 is attached to the upper frame 13. On the upper basket receiving frame 17, a shopping basket (not illustrated) that accommodates a product when a customer performs shopping is placed.

On the lower frame 12, a weight sensor 28 is installed at a position extending toward the front side. The weight sensor 28 is positioned below the upper basket receiving frame 17, and measures a weight of a product put in a shopping basket placed on the upper basket receiving frame 17.

A cart terminal 2, a hand scanner 25, a card reader 26, and a camera 27 are installed on the upper frame 13. A fixed scanner 24 is installed on the handle 16. These electronic devices operate on the power of the battery 29.

The cart terminal 2 registers a product to be purchased by a customer. The cart terminal 2 includes a display unit 22 and an operation unit 23. Note that the cart terminal 2 may further have a function of making a payment related to the registered product.

The display unit 22 displays various types of information related to product registration. The display unit 22 is, for example, a liquid crystal monitor or an organic EL monitor.

The operation unit 23 detects operations on various buttons displayed on the display unit 22. The operation unit 23 is, for example, a touch panel stacked on the display unit 22.

The fixed scanner 24 reads a code symbol such as a barcode attached to a product to be sold, the code symbol being held over the front reading window. A product code for uniquely specifying a product is registered in the code symbol. The fixed scanner 24 acquires the product code by decoding the reading result of the code symbol.

Similarly to the fixed scanner 24, the hand scanner 25 reads a code symbol attached to a product and acquires a product code. In particular, the hand scanner 25 is used to read a code symbol of a product that is difficult to read by the fixed scanner 24, for example, a heavy object or a large product.

The card reader 26 reads information registered in an IC card or a magnetic card possessed by a customer. For example, the card reader 26 reads member information registered in a customer's member card. The cart terminal 2 may display the purchase information, the service information, and the like of the product matching the preference of the customer on the display unit 22 by referring to, for example, the purchase history of the customer on the basis of the member information read by the card reader 26. Note that, in a case where the shopping cart 10 further has a function of performing settlement processing, the card reader 26 may read registration information of a credit card used for payment by a customer, a charged amount of an electronic money card, a prepaid card, or the like.

The camera 27 captures an image of a region including the shopping basket placed on the upper basket receiving frame 17. The cart terminal 2 transmits identification information for identifying itself, an image captured by the camera 27, the weight of the shopping basket measured by the weight sensor 28, and product registration information at that time to a store server (not illustrated) in association with each other.

The store server analyzes the information sent from the shopping cart 10 and monitors whether an unregistered product is put in the shopping basket. Specifically, in a case where the weight of the shopping basket increases even though no product is registered, it is determined that there is a possibility that a customer has put an unregistered product in the shopping basket. In such a case, the store server transmits a signal for calling attention to the cart terminal 2. Then, the cart terminal 2 displays a message for calling attention on the display unit 22. Further, the cart terminal 2 may output a warning sound from a speaker (not illustrated). Furthermore, the store server may notify a mobile terminal carried by a store clerk of the identification number of the corresponding shopping cart 10. The clerk who has received the notification goes to the corresponding shopping cart 10 and checks the content of the product that the customer intends to purchase and the product registration information. Such a monitoring process may be performed by the cart terminal 2 itself.

Although only the camera 27 and the weight sensor 28 that monitor the shopping basket placed on the upper basket receiving frame 17 are illustrated in FIGS. 1 and 2, the camera and weight sensor are also installed on the side of the lower basket receiving frame 18 to monitor the shopping basket placed on the lower basket receiving frame 18.

### Battery Charging Method

A method of charging the battery 29 included in the shopping cart 10 will be described with reference to FIG. 3. FIG. 3 is a view illustrating a state in which the battery is being charged in a state in which the shopping carts of the embodiment are stacked.

By inserting the pair of bottom frames 11 of the shopping cart 10 at the subsequent stage between the pair of bottom frames 11 of the shopping cart 10, it is possible to accumulate more shopping carts 10 in a narrow area as illustrated in FIG. 3. Hereinafter, a state in which the plurality of shopping carts 10 are accumulated in this manner is referred to as a stacked state.

When the shopping cart 10 is stacked, the charging unit 4 of the shopping cart 10 at the preceding stage and the charging unit 4 of the shopping cart 10 at the subsequent stage are in a state of being butted against each other along the front-rear direction (X-axis direction). At this time, the output connector 8 of the shopping cart 10 at the preceding stage and the input connector 7 of the shopping cart 10 at the subsequent stage are connected. In addition, the input connector 7 of the first shopping cart 10 is connected to the output connector 8 of the power supply unit 5.

At this time, a voltage signal from the power supply unit 5 is supplied to the first shopping cart 10 via the input connector 7. This voltage signal is supplied to the battery 29 of the first shopping cart 10, whereby the battery 29 of the first shopping cart 10 is charged.

The voltage signal supplied to the first shopping cart 10 is supplied to its own battery 29, and is supplied from the output connector 8 of the shopping cart 10 to the input connector 7 of the second shopping cart 10. This voltage signal is supplied to the battery 29 of the second shopping cart 10, whereby the battery 29 of the second shopping cart 10 is charged. Thereafter, similarly, the battery 29 of the shopping cart 10 at the subsequent stage is charged. The number of the shopping carts 10 that can be charged at the same time (the number of batteries 29) depends on the power capacity of the power supply unit 5 and the capacity of the battery 29 included in the shopping cart 10, but for example, about ten batteries 29 of the shopping carts 10 can be charged at a time.

### Hardware Configuration of Shopping Cart

A hardware configuration of the shopping cart 10 will be described with reference to FIG. 4. FIG. 4 is a hardware block diagram illustrating an example of a hardware configuration of the shopping cart according to the embodiment.

The shopping cart 10 includes a cart terminal 2, a charging unit 4, a battery 29, an indicator 43, a fixed scanner 24 which is a peripheral device, a hand scanner 25, a card reader 26, a camera 27, and a weight sensor 28.

The cart terminal 2 performs various processing related to product registration. The cart terminal 2 includes a control unit 21, a display unit 22, and an operation unit 23. Note that the cart terminal 2 is an example of a product sales data processing device in the present disclosure.

The control unit 21 controls processing performed by the cart terminal 2 itself. In addition, the control unit 21 controls operations of various peripheral devices connected thereto. The control unit 21 includes a CPU, a RAM, a ROM, and a storage unit. The CPU causes the cart terminal 2 to perform predetermined processing related to product registration or the like by developing a control program stored in the storage unit in the RAM and executing the control program. The functions of the display unit 22 and the operation unit 23 included in the cart terminal 2 are as described above.

The functions of the fixed scanner 24, the hand scanner 25, the card reader 26, the camera 27, and the weight sensor 28, which are peripheral devices connected to the control unit 21, are as described above.

The charging unit 4 charges the battery 29. The charging unit 4 includes an input connector 7, an output connector 8, a charging circuit 41, an energization control circuit 42, and a housing 44. The housing 44 is fixed to the frame 20. The input connector 7 and the output connector 8 are supported by the housing 44 and exposed to the outside of the housing 44. The charging circuit 41 and the energization control circuit 42 are accommodated in the housing 44.

The input connector 7 receives a voltage signal from the power supply unit 5. In addition, the input connector 7 receives a voltage signal from the output connector 8 included in the charging unit 4 of the shopping cart 10 at the subsequent stage. As described above, each of the shopping cart 10 and the power supply unit 5 includes the output connector 8. Hereinafter, in order to distinguish the shopping cart 10 and the power supply unit 5 from each other, the output connector 8 of the shopping cart 10 may be referred to as an output connector 61, and the output connector 8 of the power supply unit 5 may be referred to as an output connector 62. In other words, the output connector 8 is a generic term for the output connector 61 of the shopping cart 10 and the output connector 62 of the power supply unit 5. Note that the voltage signal is transmitted through two signal lines: a signal line that transmits a voltage signal; and a ground line that transmits a ground (GND) level, which is a reference potential. That is, the input connector 7 includes two terminals. In the present embodiment, the input connector 7 includes a plug.

The output connector 8 outputs a voltage signal to the input connector 7 included in the charging unit 4 of the shopping cart 10 at the subsequent stage. Two signal lines, a signal line for outputting a voltage signal and a signal line for outputting a ground level, are connected to the output connector 8. In the present embodiment, the output connector 8 includes a socket.

The charging circuit 41 supplies a voltage signal necessary for charging to the battery 29.

The energization control circuit 42 supplies a voltage signal to the shopping cart 10 at the subsequent stage only when the shopping cart 10 at the subsequent stage is connected to the shopping cart 10 at the preceding stage. On the other hand, in a case where the shopping cart 10 at the subsequent stage is not connected, the energization control circuit 42 does not output the voltage signal from the output connector 8. As a result, there is no risk of electric shock even in a case where the hand accidentally touches the output connector 8.

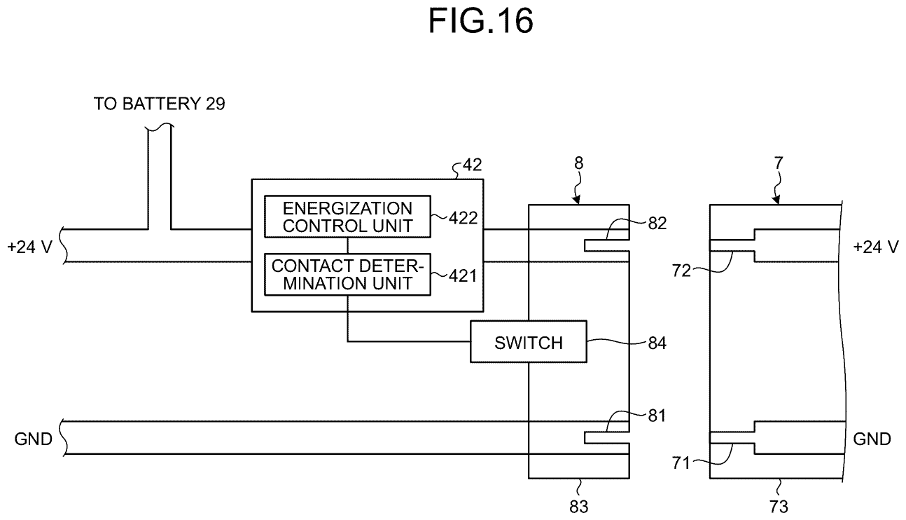

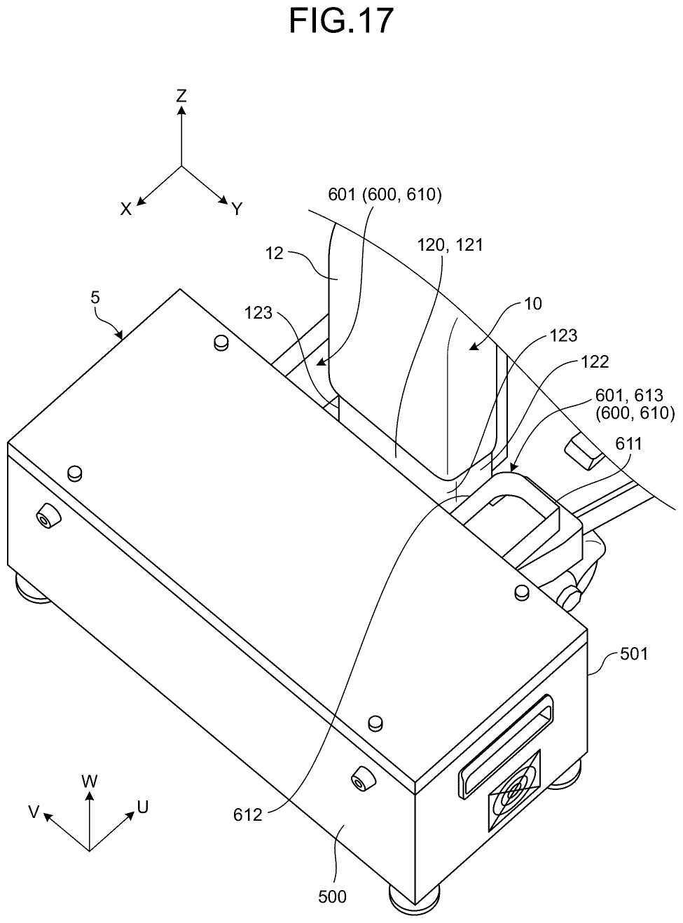

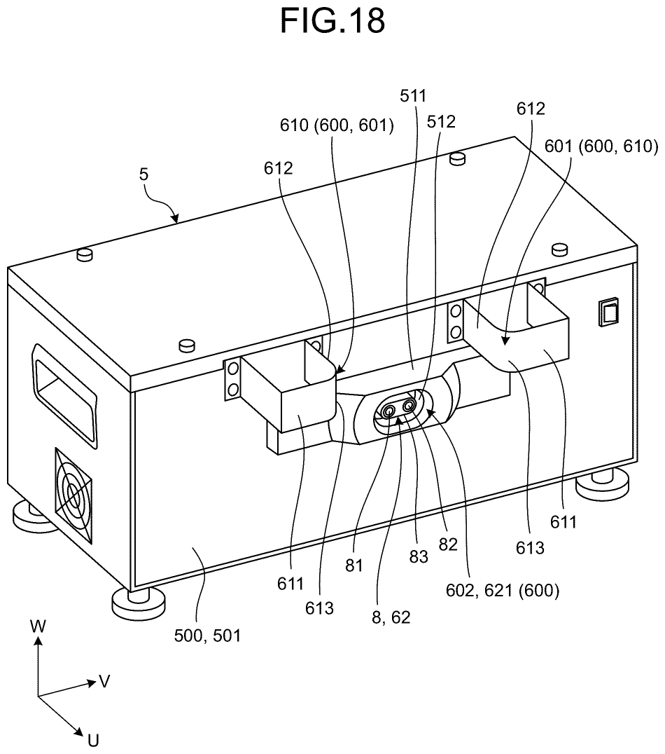

Further, in a case where the socket that outputs the voltage signal and the plug that receives the voltage signal reliably come into contact with each other, and the socket connected to the ground line and the plug that takes over the ground potential reliably come into contact with each other, the energization control circuit 42 supplies the voltage signal to the shopping cart 10 at the subsequent stage. As a result, since the voltage signal is not output in a case where the contact of any one of the signal lines is unstable, there is no possibility of hindering the operation of the charging circuit 41 of the shopping cart 10 at the subsequent stage. The configuration of the energization control circuit 42 will be described later in detail (see FIG. 16).

The battery 29 is as described above.

The indicator 43 includes, for example, an LED, and displays a state of charge of the battery 29 by the charging circuit 41. The indicator 43 displays at least a fully charged state and a charging state.

Since the various peripheral devices connected to the control unit 21 are as described above, the description thereof will be omitted again.

The power supply unit 5 is, for example, a DC power supply device that supplies power for charging the battery 29 to the charging unit 4. The power supply unit 5 includes a power transmission circuit 51, an energization control circuit 42, and an output connector 8.

The power transmission circuit 51 is a power source that supplies power necessary for charging the battery 29. The power transmission circuit 51 includes, for example, an inverter circuit that converts a commercial AC voltage of 100 V into a DC voltage, and a rectifier circuit that rectifies an output of the inverter circuit and converts the output into a DC voltage.

The energization control circuit 42 and the output connector 8 are as described above.

### Structure of Output Connector Included in Shopping Cart

A structure of the output connector 8 included in the shopping cart 10 of the embodiment will be described with reference to FIGS. 5 and 6. FIG. 5 is a view illustrating a configuration of a main part of an output connector included in the shopping cart according to the embodiment. FIG. 6 is a perspective view illustrating a detailed structure of the output connector.

The output connector 8 is installed on the −X direction side of the charging unit 4, that is, on the rear side of the shopping cart 10, backward with respect to the shopping cart 10. The output connector 8 includes a socket 81, a socket 82, and a socket housing 83.

The socket 81 is formed of a conductive member, and outputs a voltage signal (for example, +24 V) from the power supply unit 5 to the shopping cart 10 at the subsequent stage. The socket 81 is also referred to as a female terminal.

The socket 82 is formed of a conductive member, and makes the ground potential of the power supply unit 5 equal to the ground potential of the shopping cart 10 at the subsequent stage. Note that the socket 82 may be an output connector of the voltage signal, and the socket 81 may be an output connector of the ground potential. The socket 82 is also referred to as a female terminal.

The socket housing 83 is molded so as to surround an outer peripheries of the socket 81 and the socket 82, and supports the socket 81 and the socket 82 in parallel at a predetermined interval. That is, the socket housing 83 includes an outer peripheral surface 831 surrounding the outer peripheries of the socket 81 and the socket 82. The socket housing 83 is fixed to the charging unit 4 by screwing or the like. The socket housing 83 is also referred to as a shell.

A switch 84 is embedded in a base of the outer peripheral surface 831 of the socket housing 83. The switch 84 includes a switch housing 841 and a switch button 842.

The switch housing 841 protects the internal structure of the switch 84 and supports the switch button 842.

The switch button 842 is supported by switch housing 841 by an elastic member such as a spring so as to reciprocate along an extending direction (X-axis direction) of sockets 81 and 82. The switch button 842 is pushed toward the +X direction side when the input connector 7 is inserted into the output connector 8. The switch 84 performs a momentary operation to be turned on in a case where the switch button 842 is pushed by a predetermined amount and to be turned off in a case where the pressing amount is less than the predetermined amount. The charging unit 4 outputs a voltage signal from the output connector 8 in a case where the switch 84 is in the ON state, and stops outputting the voltage signal in a case where the switch 84 is in the OFF state. That is, the switch 84 functions as a so-called interlock switch. The operation of the switch 84 will be described later in detail (see FIGS. 10, 11, and 12).

An output connector cover 85 is attached to the outside of the socket housing 83. The output connector cover 85 has an opening 851 through which the outer peripheral surface 831 of the socket housing 83 and the switch button 842 are exposed to the outside. The opening 851 is formed to have a size that prevents a finger from reaching the switch button 842 even when the finger is inserted from the outside. This prevents inadvertent contact with the switch button 842 and output of a voltage signal from the socket 81 and the socket 82.

Note that the similar switch 84 is also installed in the output connector 8 included in the power supply unit 5. The switch 84 functions as a so-called interlock switch.

In the present embodiment, an example in which the switch 84 is configured by a push switch is described, but the form of the switch 84 is not limited thereto. For example, the switch 84 may include a photosensor including a pair of a light emitting element and a light receiving element. Further, the switch 84 may include a magnetic sensor or a capacitive sensor.

### Structure of Input Connector Included in Shopping Cart

A structure of the input connector 7 included in the shopping cart 10 of the embodiment will be described with reference to FIGS. 7 and 8. FIG. 7 is a view illustrating a configuration of a main part of an input connector included in the shopping cart according to the embodiment. FIG. 8 is a perspective view illustrating a detailed structure of the input connector.

The input connector 7 is installed on the +X direction side of the charging unit 4, that is, on the front side of the shopping cart 10 so as to face forward with respect to the shopping cart 10. The input connector 7 includes a plug 71, a plug 72, and a plug housing 73.

The plug 71 is formed of a conductive member and is connected to the socket 81 so as to be insertable and removable. The plug 71 inputs a voltage signal (for example, +24 V) from the socket 81 to the charging unit 4 in which the plug itself is installed. The plug 71 is also referred to as a male terminal.

The plug 72 is formed of a conductive member and is connected to the socket 82 so as to be insertable and removable. The plug 72 makes its potential equal to the ground potential of the socket 82. The plug 72 is an example of an input connector in the present disclosure. Note that the plug 72 may be an input connector of the voltage signal, and the plug 71 may be an input connector of the ground potential. The plug 72 is also referred to as a male terminal.

The plug housing 73 is molded so as to surround the plug 71 and the plug 72 with a gap with respect to the plug 71 and the plug 72, and supports the plug 71 and the plug 72 in parallel at the same interval as the socket 81 and the socket 82. The plug housing 73 includes an elongated cylindrical inner peripheral surface 731, and a depth of the inner peripheral surface 731 is made deeper than a length of the plug 71 and a length of the plug 72, and a distal end portion 732 is formed at a distal end of the inner peripheral surface 731.

The plug housing 73 is fixed to the charging unit 4 by screwing or the like.

An input connector cover 74 is attached to the outside of the plug housing 73. In the input connector cover 74, an opening 741 through which the plugs 71 and 72 and the inner peripheral surface 731 protecting the plugs penetrate is formed. The input connector cover 74 is positioned below the input connector 7 and has a wall 75 that covers the input connector 7.

When the input connector 7 is connected to the output connector 8, the inner peripheral surface 731 of the plug housing 73 is inserted along the outer peripheral surface 831 of the socket housing 83, whereby the plug 71 and the socket 81 are connected, and the plug 72 and the socket 82 are connected.

In the present embodiment, the input connector 7 includes the plugs 71 and 72, and the output connector 8 includes the sockets 81 and 82, but the present invention is not limited thereto. For example, the input connector 7 may include a pogo pin, and the output connector 8 may include a flat terminal.

### Connection Auxiliary Structure by Magnet

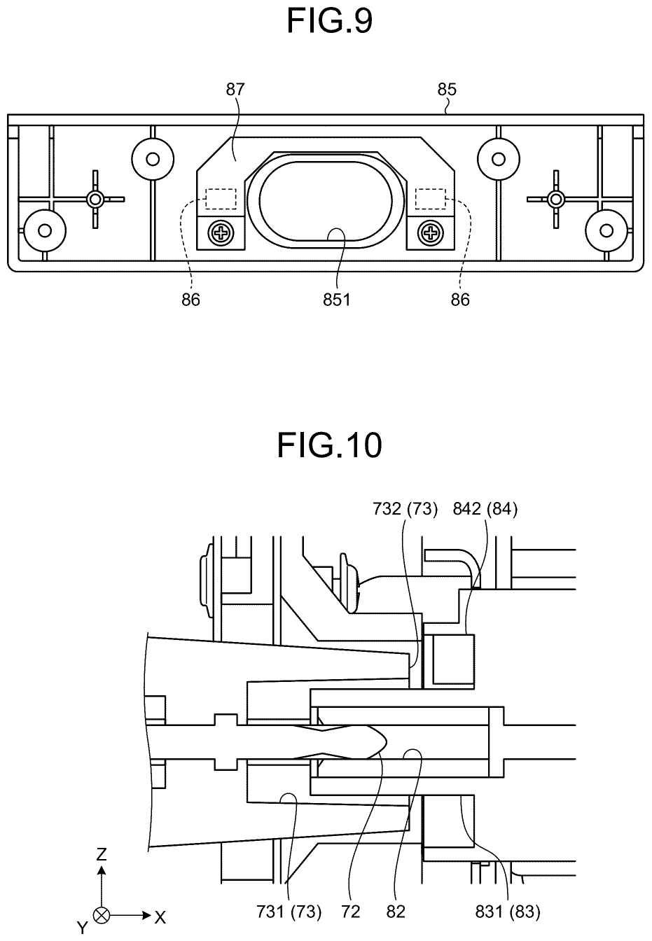

A structure that facilitates connection between the output connector 8 and the input connector 7 will be described with reference to FIG. 9. FIG. 9 is a view for explaining a magnet attached to the output connector cover.

On the back surface side of the output connector cover 85, magnets 86 are installed near the left and right of the opening 851. The magnet 86 is fixed to the back surface side of the output connector cover 85 by a magnet attachment member 87.

On the other hand, although not illustrated, a magnet or a ferromagnetic body (for example, iron) attracted to the magnet 86 is installed at a position corresponding to the magnet 86 on the back surface side of the input connector cover 74. Note that a ferromagnetic body may be installed on the back surface side of the output connector cover 85, and a magnet may be installed on the back surface side of the input connector cover 74.

When a customer inserts a pair of bottom frames 11 of the shopping cart 10 that the customer is pushing while walking between a pair of bottom frames 11 of the shopping cart 10 in front during stacking the shopping cart 10, the input connector 7 is attracted to the output connector 8 by the magnetic force of the magnet 86. As a result, the customer can guide the input connector 7 and the output connector 8 to connectable positions without performing alignment.

### Connection State Between Output Connector and Input Connector

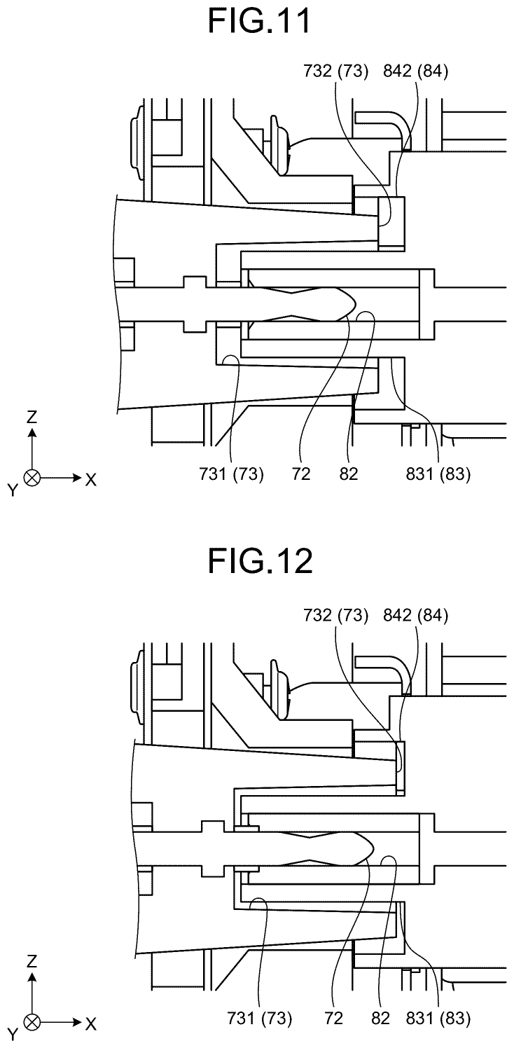

A state in which the output connector 8 and the input connector 7 are connected will be described with reference to FIGS. 10, 11, and 12. FIG. 10 is a first diagram illustrating a state in which the input connector is inserted into the output connector. FIG. 11 is a second diagram illustrating a state in which the input connector is inserted into the output connector. FIG. 12 is a third diagram illustrating a state in which the input connector is inserted into the output connector.

FIGS. 10, 11, and 12 are cross-sectional views taken along XZ axes, illustrating a state where the input connector 7 and the output connector 8 are connected at positions of the plug 72 and the socket 82. The plug 72 is inserted into the socket 82 chronologically in the order of FIGS. 10, 11, and 12.

As illustrated in FIG. 10, the plug 72 is inserted into the socket 82 by inserting the inner peripheral surface 731 of the plug housing 73 along the outer peripheral surface 831 of the socket housing 83. At this time, the distal end portion 732 of the inner peripheral surface 731 of the plug housing 73 approaches the switch button 842 of the switch 84.

When the plug housing 73 and the plug 72 are further inserted into the socket housing 83 and the socket 82, as illustrated in FIG. 11, the distal end portion 732 of the inner peripheral surface 731 of the plug housing 73 comes into contact with the switch button 842 of the switch 84 to push the switch button 842. At this time, when the pressing amount of the switch button 842 reaches a predetermined value, the switch 84 is turned on.

The timing at which the switch 84 is turned on is set to, for example, a state in which it can be considered that the plug 72 and the socket 82 are in complete contact with each other and the plug 71 and the socket 81 are in complete contact with each other. That is, when the input connector 7 and the output connector 8 are connected, the switch 84 is not shifted to the ON state at the timing when only one of the plug 72 and the socket 82 or the plug 71 and the socket 81 comes into contact with each other. As a result, when the contact state of the ground line is insufficient, the connector on the side to which the voltage signal is supplied from the power supply and the plug are prevented from coming into contact with each other, and the charging unit 4 is prevented from being energized in an incomplete state.

More specifically, the timing at which the switch 84 is turned on is appropriately set according to the length and shape of the plug 72, the depth of the socket 82, the depth of the inner peripheral surface 731 of the plug housing 73, the protrusion amount of the outer peripheral surface 831 of the socket housing 83, the installation position of the switch 84, the height of the switch button 842, and the like.

When the plug housing 73 and the plug 72 are further inserted, the switch button 842 is completely pushed in as illustrated in FIG. 12. At this time, the plug housing 73 is completely inserted into the socket housing 83.

### Detailed Structure of Output Connector and Input Connector

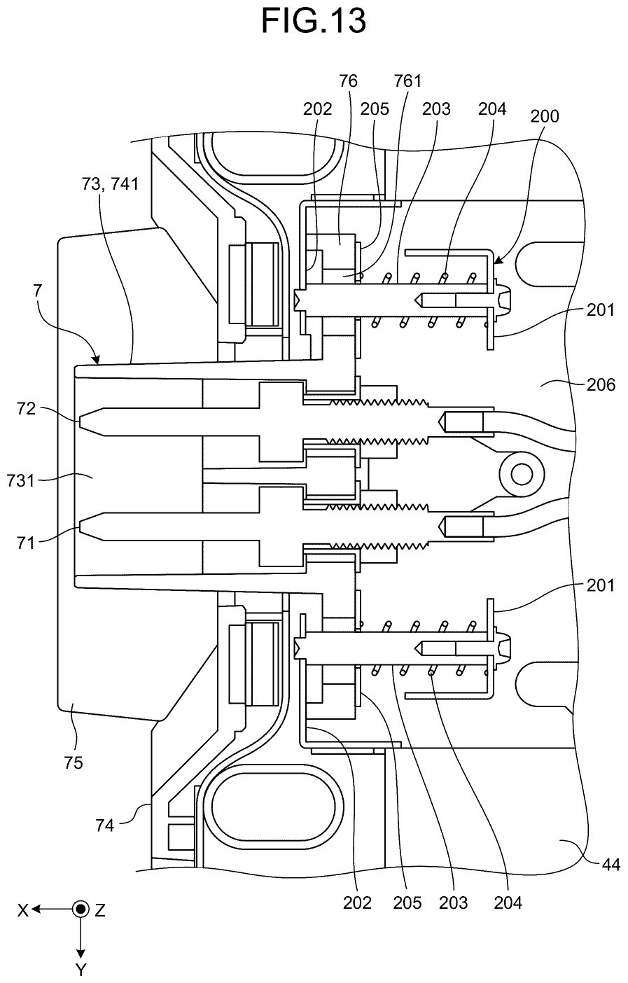

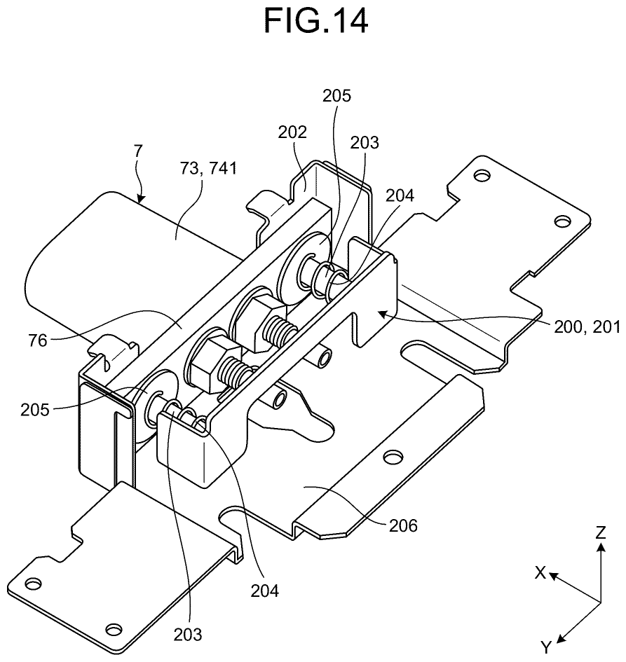

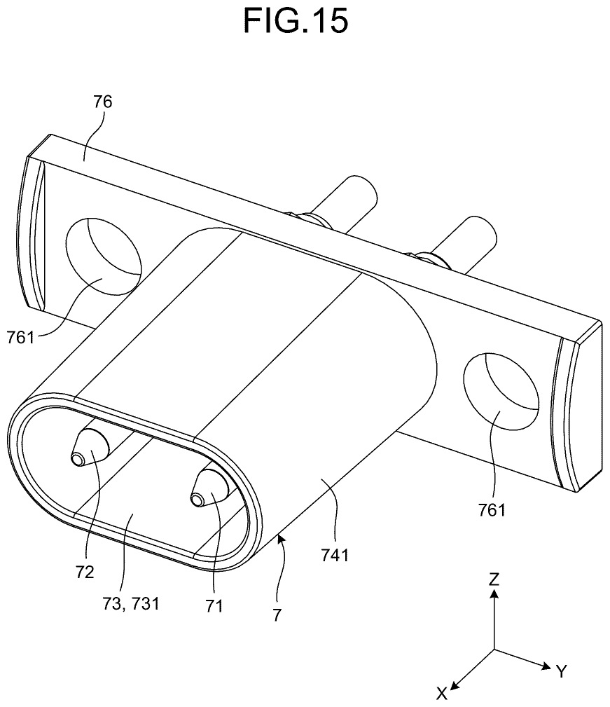

A detailed structure for improving the connectivity between the output connector 8 and the input connector 7 will be described with reference to FIGS. 13 to 15. FIG. 13 is a cross-sectional view of a portion including the input connector in the shopping cart according to the embodiment. FIG. 14 is a perspective view of a portion including the input connector in the shopping cart according to the embodiment. FIG. 15 is a perspective view of the input connector in the shopping cart according to the embodiment.

As illustrated in FIGS. 13 and 14, the input connector 7 of the shopping cart 10 is supported by a support portion 200. The support portion 200 is fixed to a bottom wall of the housing 44 of the charging unit 4. The input connector 7 is supported by the frame 20 via the housing 44.

As illustrated in FIG. 15, the input connector 7 includes a plate portion 76. The plate portion 76 is connected to an end portion of the plug housing 73 on the rear side (−X direction) in the front-rear direction of the shopping cart 10, and extends in the left-right direction (Y direction) of the shopping cart 10. In other words, the plug housing 73 protrudes from the plate portion 76 to the front side (+X direction) in the front-rear direction of the shopping cart 10. The plate portion 76 is provided with a pair of left and right through holes 761. The through hole 761 penetrates the plate portion 76 in the front-rear direction (X direction) of the shopping cart 10. The plate portion 76 is an example of a supported portion.

The support portion 200 illustrated in FIGS. 13 and 14 supports the entire input connector 7 including the plugs 71 and 72 so as to be movable with respect to the frame 20 in the front-rear direction (front and rear) of the shopping cart 10 and a direction intersecting the front-rear direction of the shopping cart 10. The direction intersecting the front-rear direction of the shopping cart 10 includes the left-right direction and the up-down direction of the shopping cart 10. That is, the direction intersecting the front-rear direction of the shopping cart 10 includes a direction orthogonal to the front-rear direction of the shopping cart 10.

The support portion 200 includes two fixing walls 201 and 202, two shafts 203, two elastic members 204, two washers 205, and a base 206. The fixing walls 201 and 202 are examples of a fixing portion.

The two fixing walls 201 and 202 are arranged at intervals in the front-rear direction of the shopping cart 10. That is, the two fixing walls 201 and 202 are disposed apart from each other in the front-rear direction of the shopping cart 10. The fixing wall 201 is a fixing wall on the front side of the two fixing walls 201 and 202, and the fixing wall 202 is a fixing wall on the rear side of the two fixing walls 201 and 202.

The two fixing walls 201 and 202 are fixed to the base 206. The base 206 is fixed to the housing 44 of the charging unit 4. That is, the two fixing walls 201 and 202 are fixed to the frame 20 via the base 206 and the housing 44.

The two shafts 203 are provided over the two fixing walls 201 and 202 and extend in the front-rear direction of the shopping cart 10. The two shafts 203 are inserted into the two through holes 761 of the plate portion 76 of the input connector 7. The shaft 203 supports the input connector 7 so as to be movable in the front-rear direction of the shopping cart 10. The diameter of the shaft 203 is smaller than the diameter of the through hole 761. As a result, the plate portion 76 and the input connector 7 can move by a predetermined amount in a direction orthogonal to the front-rear direction of the shopping cart 10.

The two elastic members 204 are coil springs, for example. The elastic member 204 is interposed between the plate portion 76 of the input connector 7 and the fixing wall 202 in a state where the shaft 203 is inserted inside. In addition, a washer is interposed between the elastic member 204 and the plate portion 76. The elastic member 204 may be a leaf spring or an elastomer.

The elastic member 204 is interposed in a compressed state between the plate portion 76 of the input connector 7 and the fixing wall 202, and pushes the plate portion 76 and the input connector 7 forward in the front-rear direction of the shopping cart 10. That is, the elastic member 204 generates an elastic force to push the input connector 7 forward in the front-rear direction of the shopping cart 10. The elastic member 204 elastically supports the input connector 7. The plate portion 76 of the input connector 7 is pushed against the fixing wall 201 by the elastic force of the elastic member 204.

As described above, the support portion 200 supports the input connector 7 so as to be movable with respect to the frame 20 in the front-rear direction (front and rear) of the shopping cart 10 and the direction intersecting the front-rear direction of the shopping cart 10. Therefore, in a case where the output connector 8 moves in a state where the input connector 7 and the output connector 8 are coupled, the input connector 7 can move according to the movement of the output connector 8.

In addition, the elastic member 204 pushes the plate portion 76 and the input connector 7 forward in the front-rear direction of the shopping cart 10. Therefore, in a case where a load (impact) toward the rear side in the front-rear direction of the shopping cart 10 is input from the output connector 8 to the input connector 7 at the time of coupling the input connector 7 and the output connector 8, the input connector 7 can move to the rear side in the front-rear direction while the elastic member 204 is compressed according to the load. That is, the elastic member 204 can absorb a load (impact) acting on the input connector 7. The rear side of the shopping cart 10 in the front-rear direction is an example of a first direction.

### Functional Configuration of Energization Control Circuit

A functional configuration of the energization control circuit 42 included in the charging unit 4 will be described with reference to FIG. 16. FIG. 16 is a block diagram illustrating an example of a functional configuration of an energization control circuit included in the shopping cart according to the embodiment.

The energization control circuit 42 includes a contact determination unit 421 and an energization control unit 422.

The contact determination unit 421 is provided on the socket 81 and the socket 82 side, that is, the output connector side, and detects whether the sockets 81 and 82 and the plugs 71 and 72 are in a predetermined contact state. The contact determination unit 421 includes the switch 84 that is installed in the socket housing 83 and detects that the plugs 71 and 72 are inserted into the sockets 81 and 82 by a predetermined amount, and determines that the output connector and the input connector are in a predetermined contact state on condition that the switch 84 detects that the plugs 71 and 72 are inserted into the sockets 81 and 82 by a predetermined amount.

The contact determination unit 421 includes, for example, a circuit that conducts or outputs a predetermined voltage when the switch 84 is turned on. A specific circuit configuration is not limited. Note that the contact determination unit 421 may include a circuit that becomes non-conductive when the switch 84 is turned off.

The energization control unit 422 energizes the plugs 71 and 72 from the sockets 81 and 82 on condition that the contact determination unit 421 determines that the contact state is a predetermined contact state, and does not energize the plugs 71 and 72 from the sockets 81 and 82 on condition that the contact determination unit 421 does not determine that the contact state is a predetermined contact state.

The energization control unit 422 includes, for example, a switching circuit that conducts with an output of a circuit included in the contact determination unit 421 as a trigger. Although a specific circuit configuration of the switching circuit is not limited, for example, a switching circuit using an FET may be used, or a mechanical or electrical relay may be used. Note that the energization control unit 422 is only required to control the energization state of at least the side of the sockets 81 and 82 from which the voltage signal from the power supply is output. Note that the energization control unit 422 may be configured by a switching circuit that becomes non-conductive with an output of a circuit configured by the contact determination unit 421 as a trigger.

As illustrated in FIG. 4, the power supply unit 5 also includes the energization control circuit 42. Accordingly, when the first shopping cart 10 is connected to the power supply unit 5, the power supply unit 5 performs energization on condition that the sockets 81 and 82 and the plugs 71 and 72 are determined to be in a predetermined contact state.

Detailed Structure of Power Supply Unit FIG. 17 is a perspective view illustrating a state in which the power supply unit of the embodiment and the shopping cart are coupled. FIG. 18 is a perspective view of the power supply unit according to the embodiment.

As illustrated in FIGS. 17 and 18, the power supply unit 5 includes a housing 500, an output connector 62, an output connector cover 511, and a guide device 600. The power supply unit 5 is installed (fixed) on a floor surface 1000 (see FIG. 3) of a store, for example.

In the present specification, for convenience, a UVW coordinate system including a U axis, a V axis, and a W axis is defined. The UVW coordinate system is provided for the power supply unit 5. The U axis, the V axis, and the W axis are orthogonal to each other. The U axis is provided along the front-rear direction of the power supply unit 5. The V axis is provided along the width direction (left-right direction) of the power supply unit 5. The W axis is provided along the up-down direction of the power supply unit 5.

Further, in the present specification, a U direction, a V direction, and a W direction are defined. The U direction is a direction along the U axis, and includes a +U direction indicated by an arrow of the U axis and a −U direction which is an opposite direction of the arrow of the U axis. The V direction is a direction along the V axis, and includes a +V direction indicated by an arrow of the V axis and a −V direction which is an opposite direction of the arrow of the V axis. The W direction is a direction along the W axis, and includes a +W direction indicated by an arrow of the W axis and a −W direction which is an opposite direction of the arrow of the W axis. In addition, the +W direction is the same as the upward direction in the vertical direction, and the −W direction is the same as the downward direction in the vertical direction.

The housing 500 is formed in a rectangular parallelepiped shape. The housing 500 accommodates the energization control circuit 42 and the power transmission circuit 51 therein.

The output connector 62 protrudes forward (in the +U direction) in the front-rear direction of the power supply unit 5 from a front surface 501 of the housing 500, and is exposed to the outside of the housing 500. The output connector 62 is coupled with the input connector 7 of the shopping cart 10 that moves to the rear side (in the −U direction) in the front-rear direction of the power supply unit 5 by fitting engagement. That is, a rear side (−U direction) of the power supply unit 5 in the front-rear direction is a mounting direction (insertion direction) of the input connector 7 with respect to the output connector 62. In other words, the power supply unit 5 is coupled by fitting with the output connector 8 relatively moving to the rear side (first direction) in the front-rear direction of the shopping cart 10 with respect to the plugs 71 and 72 of the shopping cart 10. The rear side of the shopping cart 10 in the front-rear direction is a mounting direction (insertion direction) of the output connector 62 with respect to the input connector 7. The output connector 62 is coupled with the input connector 7 of the shopping cart 10 that moves to the rear side (in the −U direction) in the front-rear direction of the power supply unit 5 by fitting engagement. That is, a rear side (−U direction) of the power supply unit 5 in the front-rear direction is a mounting direction (insertion direction) of the input connector 7 with respect to the output connector 62. The configuration of the output connector 62 is the same as the configuration of the output connector 61 of the shopping cart 10. The input connector 7 of the shopping cart 10 is an example of a first connector. The plugs 71 and 72 of the input connector 7 are examples of terminals. The output connector 62 is an example of an external connector. In addition, the output connector 61 of the shopping cart 10 at the preceding stage is an example of an external connector with respect to the input connector 7 of the shopping cart 10 at the subsequent stage.

The output connector cover 511 is mounted on the outside of the socket housing 83 of the output connector 62. The output connector cover 511 is fixed to the front surface 501 of the housing 500. The output connector cover 511 has an opening 512 through which the outer peripheral surface 831 of the socket housing 83 and the switch button 842 are exposed to the outside. The opening 512 is formed to have a size that prevents a finger from reaching the switch button 842 even when the finger is inserted from the outside. This prevents inadvertent contact with the switch button 842 and output of a voltage signal from the socket 81 and the socket 82.

The guide device 600 illustrated in FIG. 18 guides the input connector 7 of the shopping cart 10 to the output connector 62 of the power supply unit 5. In other words, the guide device 600 leads the input connector 7 of the shopping cart 10 to the output connector 62 of the power supply unit 5. The guide device 600 is also referred to as a lead device.

The guide device 600 includes a first guide portion 601 and a second guide portion 602.

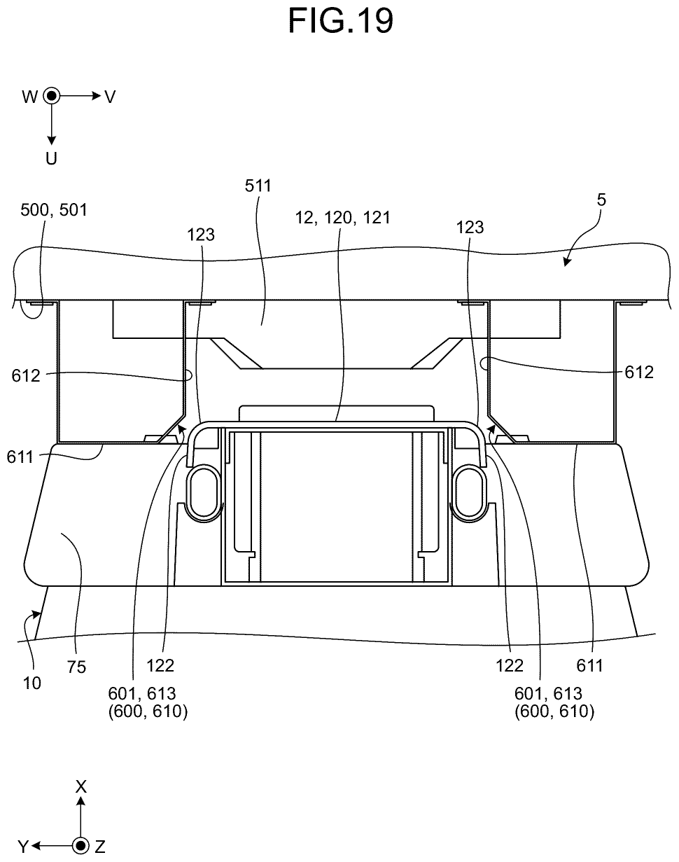

FIG. 19 is a cross-sectional view of a portion including the first guide portion in the power supply unit of the embodiment and a portion including the guided portion in the shopping cart, illustrating a state in which the output connector of the power supply unit and the input connector of the shopping cart are separated from each other. As illustrated in FIGS. 18 and 19, the first guide portion 601 is provided on the front surface 501 of the housing 500. The first guide portion 601 guides the shopping cart 10 such that the input connector 7 faces the output connector 62 by coming into contact with the guided portion 120 (FIG. 19) of the shopping cart 10 moving toward the power supply unit 5. At this time, the first guide portion 601 guides the shopping cart 10 so that the distal end portion of the input connector 7 enters the second guide portion 602 by coming into contact with the guided portion 120 (FIG. 19) of the shopping cart 10 moving toward the power supply unit 5.

Here, the guided portion 120 of the shopping cart 10 guided by the first guide portion 601 will be described. As illustrated in FIG. 19, the guided portion 120 is included in the lower frame 12. The guided portion 120 has a front surface 121, a pair of left and right side surfaces 122, and a pair of left and right corners 123. The pair of left and right corners 123 connects the front surface 121 and the pair of left and right side surfaces 122. The corner 123 is, for example, a convex curved surface. The guided portion 120 is an example of a portion other than the input connector 7 in the shopping cart 10. The portion other than the input connector 7 in the shopping cart 10 may be a portion forming the outer shape of the shopping cart 10.

As illustrated in FIGS. 18 and 19, the first guide portion 601 is installed at a position shifted in the vertical direction with respect to the input connector 7. Specifically, the first guide portion 601 is positioned above the input connector 7 in the vertical direction.

The first guide portion 601 includes a pair of left and right guide members 610. The pair of left and right guide members 610 protrudes forward in the front-rear direction of the power supply unit 5 from the front surface 501 of the housing 500. The pair of left and right first guide portions 601 is provided to be separated from each other in the left-right direction (horizontal direction) of the power supply unit 5. The pair of left and right guide members 610 has a symmetrical shape with respect to a predetermined plane orthogonal to the U direction. The guide member 610 is made of, for example, a metal material, but is not limited thereto.

Each of the pair of left and right guide members 610 has a front surface 611, a side surface 612, and a guide surface 613. The side surface 612 of one guide member 610 and the side surface 612 of the other guide member 610 are separated from each other in the left-right direction (horizontal direction) of the power supply unit 5 and face each other in the V direction. The guide surface 613 connects the front surface 611 and the side surface 612. The pair of guide surfaces 613 of the pair of left and right guide members 610 is provided to be separated from each other in the left-right direction (horizontal direction) of the power supply unit 5, and approach each other toward the output connector 62, that is, toward the rear side (−U direction) of the power supply unit 5 in the front-rear direction. The guide surface 613 may be a flat surface or a curved surface. The pair of guide surfaces 613 guides (leads) the shopping cart 10 such that the input connector 7 is directed toward the output connector 62 by coming into contact with the guided portion 120 that has entered between the pair of guide surfaces.

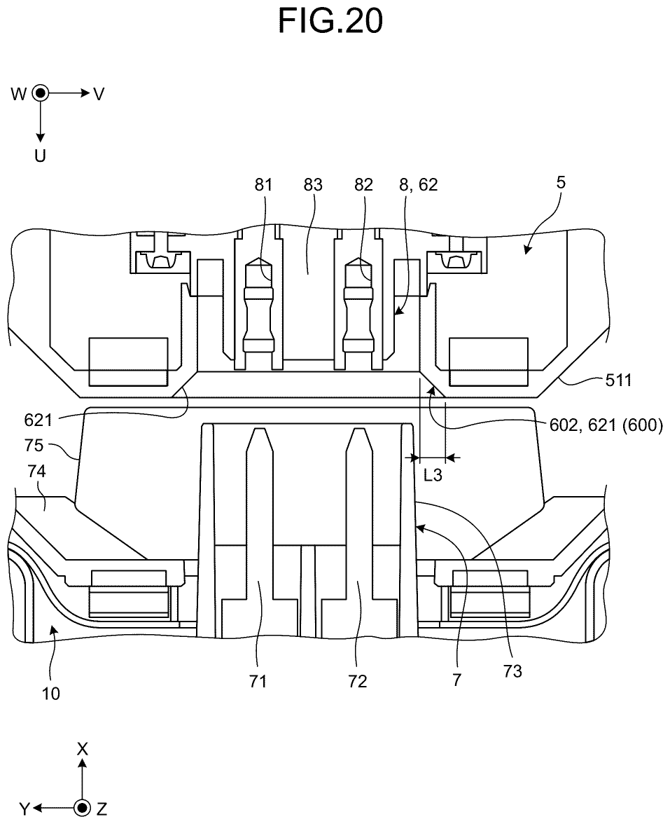

FIG. 20 is a cross-sectional view of a portion including a second guide portion in the power supply unit of the embodiment and a portion including the input connector in the shopping cart, illustrating a state in which the output connector of the power supply unit and the input connector of the shopping cart are separated from each other. As illustrated in FIGS. 18 and 20, the second guide portion 602 is provided on the output connector cover 511. The second guide portion 602 guides the input connector 7 to the output connector 62 by coming into contact with the input connector 7 of the shopping cart 10 that moves toward the power supply unit 5 upon receiving the guide of the first guide portion 601.

Specifically, the second guide portion 602 has a cylindrical surface 621. The cylindrical surface 621 is provided on the output connector cover 511. The output connector cover 511 including the second guide portion 602 is made of, for example, a synthetic resin material or a synthetic resin material containing a fiber, but is not limited thereto. The cylindrical surface 621 approaches the output connector 62 as it goes to the rear side (in the −U direction) in the front-rear direction of the power supply unit 5. The cylindrical surface 621 guides (leads) the input connector 7 to the output connector 62 by coming into contact with the input connector 7 that has entered the inside of the cylindrical surface 621 in the shopping cart 10 that moves toward the power supply unit 5 upon receiving the guide of the first guide portion 601.

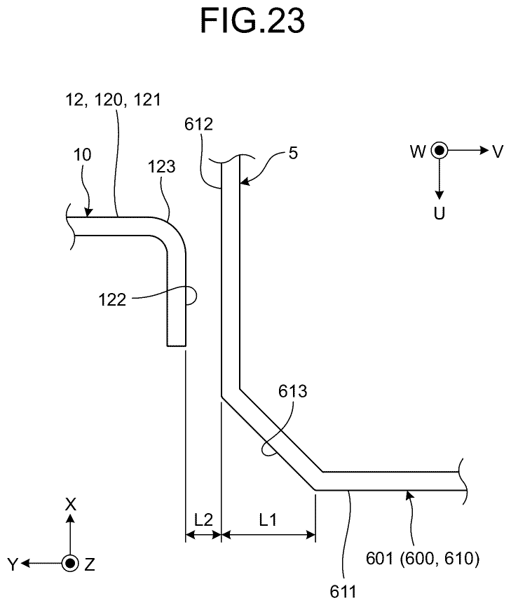

The guiding amount of the input connector 7 by the second guide portion 602 in the width direction (V direction) of the output connector 62 is smaller than the guiding amount of the input connector 7 of the first guide portion 601 in the width direction of the output connector 62. In other words, the guiding amount of the input connector 7 of the first guide portion 601 in the width direction of the output connector 62 is larger than the guiding amount of the input connector 7 of the second guide portion 602 in the width direction of the output connector 62. Specifically, a width L1 (see FIG. 23) of the guide surface 613 of the first guide portion 601 in the width direction of the output connector 62 is larger than a width L3 (see FIG. 20) of the cylindrical surface 621 of the second guide portion 602 in the width direction of the output connector 62.

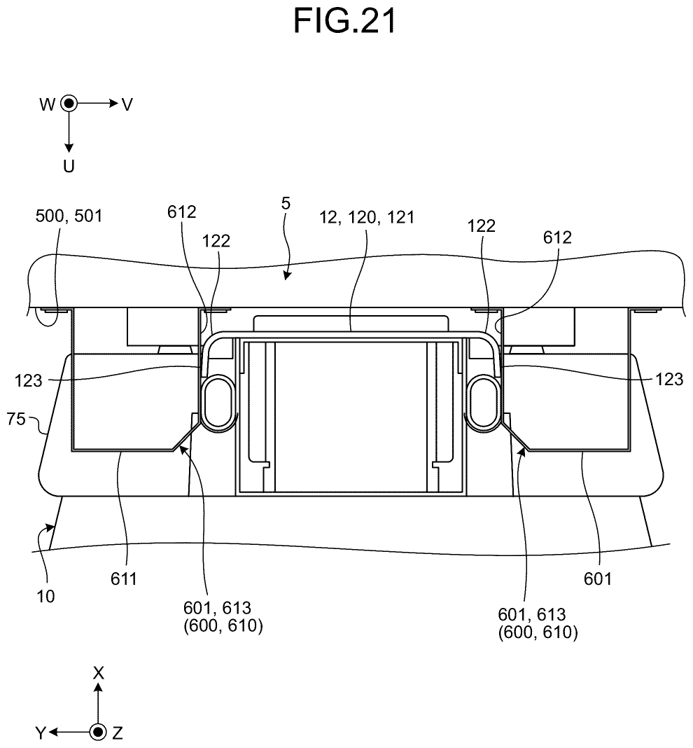

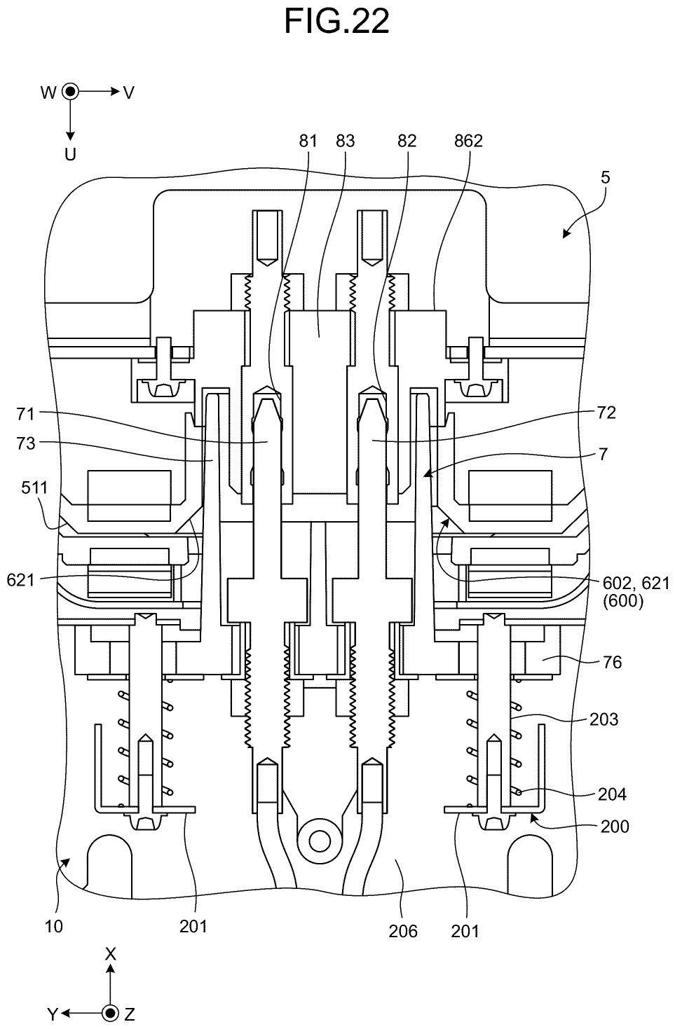

FIG. 21 is a cross-sectional view of a portion including the first guide portion in the power supply unit of the embodiment and a portion including the guided portion in the shopping cart, illustrating a state in which the output connector of the power supply unit and the input connector of the shopping cart are coupled. FIG. 22 is a cross-sectional view of a portion including the second guide portion in the power supply unit of the embodiment and a portion including the input connector in the shopping cart, illustrating a state in which the output connector of the power supply unit and the input connector of the shopping cart are coupled. As illustrated in FIG. 21, when the guided portion 120 of the shopping cart 10 enters the first guide portion 601 by a predetermined amount, the input connector 7 of the shopping cart 10 is completely coupled to the output connector 62 of the power supply unit 5 as illustrated in FIG. 22. That is, the guide device 600 positions the input connector 7 with respect to the output connector 62.

FIG. 23 is a view illustrating a relationship between the first guide portion and the guided portion according to the embodiment. In the present embodiment, the first guide portion 601 guides the guided portion 120 to guide the input connector 7 into the cylindrical surface 621 of the second guide portion 602. In order to realize this, in the present embodiment, as illustrated in FIG. 23, in a state where the guided portion 120 of the shopping cart 10 enters between the two side surfaces 612 of the first guide portion 601, and the input connector 7 of the shopping cart 10 and the output connector 62 of the power supply unit 5 are coupled, an interval L2 between the side surface 122 of the guided portion 120 and the side surface 612 of the first guide portion 601 is smaller than the width L1 of the guide surface 613 of the first guide portion 601 in the width direction of the output connector 62. In other words, the width L1 of the guide surface 613 of the first guide portion 601 in the width direction of the output connector 62 is larger than the interval L2 between the side surface 122 of the guided portion 120 and the side surface 612 of the first guide portion 601.

### Operation and Effect of Embodiment

As described above, the shopping cart 10 (hand-driving movable body) includes the frame 20 (base), at least three wheels (front wheel 14, rear wheel 15), the input connector 7, and the support portion 200. The wheels (front wheel 14, rear wheel 15) are coupled with the frame 20. The input connector 7 has the plugs 71 and 72 (terminals), and is coupled by fitting with an external connector (the power supply unit 5 or the output connector 8 of the shopping cart 10 at the subsequent stage) relatively moving to the rear side (first direction) of the shopping cart 10 in the front-rear direction with respect to the plugs 71 and 72. The support portion 200 supports the plugs 71 and 72 so as to be movable with respect to the frame 20 in the rear side of the shopping cart 10 in the front-rear direction and in the direction intersecting the rear side.

According to such a configuration, since the support portion 200 supports the plugs 71 and 72 so as to be movable with respect to the frame 20 in the rear side of the shopping cart 10 in the front-rear direction and in the direction intersecting the rear side, it is possible to suppress the plugs 71 and 72 of the input connector 7 from being damaged in a state where (the power supply unit 5 or the output connector 8 of the shopping cart 10 in the preceding stage) is coupled to the input connector 7 of the shopping cart 10. As a result, breakage of the external connector can also be suppressed.

In addition, the support portion 200 supports the input connector 7 so as to be movable with respect to the frame 20 in the rear side of the shopping cart 10 in the front-rear direction and in the direction intersecting the rear side.

According to such a configuration, in a state where (the power supply unit 5 or the output connector 8 of the shopping cart 10 in the preceding stage) is coupled to the input connector 7 of the shopping cart 10, it is possible to suppress the breakage of the entire input connector 7.

Further, the support portion 200 includes the elastic member 204 that generates an elastic force for pushing the input connector 7 in a direction opposite to the rear side of the shopping cart 10 in the front-rear direction.

According to such a configuration, when the external connector is coupled to the input connector 7, for example, a rearward impact in the front-rear direction of the shopping cart 10 acting on the input connector 7 can be absorbed by the elastic force of the elastic member 204. Therefore, the breakage of the input connector 7 can be suppressed even when the external connector is coupled to the input connector 7.

In addition, the input connector 7 includes a plate portion 76 (supported portion). The plate portion 76 is provided with a through hole 761 penetrating the plate portion 76 in the first direction. The support portion 200 includes a pair of fixing walls 201 and 202 (fixing portions), a shaft 203, and an elastic member 204. The pair of fixing walls 201 and 202 is separated in the front-rear direction (rear side) of the shopping cart 10. The shaft 203 extends to the rear side in the front-rear direction of the shopping cart 10, is put in the through hole 761, and extends over the pair of fixing walls 201 and 202. The elastic member 204 is interposed between the plate portion 76 and the fixing wall 202 on the rear side in the front-rear direction of the shopping cart 10 out of the pair of fixing walls 201 and 202.

According to such a configuration, since the plate portion 76 and the input connector 7 can be pushed against the fixing wall 201 by the elastic member 204, the position of the input connector 7 can be held in a state where the input connector 7 is not coupled to the external connector.

Further, the guide device 600 guides the input connector 7 of the shopping cart 10 having the frame 20, at least three wheels (front wheel 14, rear wheel 15) coupled to the frame 20, and the input connector 7 supported by the frame 20 to the output connector 62 of the power supply unit 5 having the output connector 62 connectable to the input connector 7. The guide device 600 is provided with a first guide portion 601 and a second guide portion 602. The first guide portion 601 guides the shopping cart 10 such that the input connector 7 is directed to the output connector 62 by coming into contact with the guided portion 120 which is a portion other than the input connector 7 in the shopping cart 10 moving toward the power supply unit 5. The second guide portion 602 guides the input connector 7 to the output connector 62 by coming into contact with the input connector 7 of the shopping cart 10 that moves toward the power supply unit 5 upon receiving the guide of the first guide portion 601.

According to such a configuration, since the first guide portion 601 guides the input connector 7 to the output connector 62 after guiding the shopping cart 10 such that the input connector 7 faces the output connector 62, the input connector 7 of the shopping cart 10 can be easily coupled to the output connector 62 of the power supply unit 5.

In addition, the guiding amount of the first guide portion 601 in the width direction of the output connector 62 is larger than the guiding amount of the second guide portion 602 in the width direction of the output connector.

According to such a configuration, after the position of the input connector 7 with respect to the output connector 62 is roughly adjusted by the first guide portion 601, the position of the input connector 7 with respect to the output connector 62 can be finely adjusted by the second guide portion 602.

The first guide portion 601 has a pair of guide surfaces 613. The pair of guide surfaces 613 is provided to be separated from each other in the horizontal direction, and approaches each other toward the output connector 62. The pair of guide surfaces 613 guides the shopping cart 10 such that the input connector 7 is directed toward the output connector 62 by coming into contact with the guided portion 120 that has entered between the pair of guide surfaces.

According to such a configuration, for example, the input connector 7 of the shopping cart 10 can be more easily coupled to the output connector 62 of the power supply unit 5 as compared with a configuration in which the guide surface 613 is one.

In addition, the output connector 62 is coupled by fitting with the input connector 7 that moves to the rear side in the front-rear direction of the guide device 600. The second guide portion 602 has a cylindrical surface 621 that approaches the output connector 62 as it goes to the rear side in the front-rear direction of the guide device 600. The cylindrical surface 621 guides the input connector 7 to the output connector 62 by coming into contact with the input connector 7 that has entered the inside of the cylindrical surface 621 in the shopping cart 10 that moves toward the power supply unit 5 upon receiving the guide of the first guide portion 601.

According to such a configuration, since the guide device 600 guides the input connector 7 to the output connector 62 by the cylindrical surface 621, it is possible to adjust the position of the input connector 7 in the up-down direction and the left-right direction. Therefore, the input connector 7 of the shopping cart 10 can be more easily coupled to the output connector 62 of the power supply unit 5.

In addition, the first guide portion 601 is installed at a position shifted in the vertical direction with respect to the input connector 7.

According to such a configuration, since the input connector 7 hardly collides with the first guide portion 601, it is possible to suppress breakage of the input connector 7.

In the above embodiment, the example in which the guide device 600 is provided in the power supply unit 5 has been described, but the present invention is not limited thereto. For example, an example in which the guide device 600 is provided in the power supply unit 5 is shown, but the present invention is not limited thereto. For example, the guide device 600 may be provided in the shopping cart 10 to guide the input connector 7 of the shopping cart 10 at the subsequent stage of the shopping cart 10 to the output connector 8 of the shopping cart 10. In this case, for example, the first guide portion may be constituted by the lower basket receiving frame 18 having a pair of left and right guide surfaces 181, and the second guide portion may be provided in the socket housing 83. At least one of the first guide portion and the second guide portion of the guide device 600 may be disposed on the floor surface 1000. For example, as the first guide portion, the first guide portion comes into contact with the front wheel 14 and guides the first guide portion to the output connector 8 of the power supply unit 5, but may be a rib or the like.

In the above embodiment, the example of the charging connector in which the input connector 7 and the output connector 8 exchange power has been described, but the present invention is not limited thereto. For example, the input connector 7 and the output connector 8 may be communication connectors that exchange communication signals.

In the above embodiment, the example is shown in which the support portion 200 supports the input connector 7 by the fixed shaft 203 so as to be movable with respect to the frame 20 in the front-rear direction (front and rear) of the shopping cart 10 and the direction intersecting the front-rear direction of the shopping cart 10, but the present invention is not limited thereto. For example, the support portion 200 may be configured to support the base end portion of the input connector 7 so that the input connector 7 pivots about the base end portion (−X direction side) of the input connector 7 as a fulcrum.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A hand-driving movable body comprising:
a base;
at least three wheels coupled to the base;
a first connector that has a terminal and is coupled by fitting with an external connector that moves in a first direction relative to the terminal; and
a support portion that movably supports the terminal with respect to the base in the first direction and a direction intersecting the first direction.

2. The hand-driving movable body according to claim 1, wherein
the support portion supports the first connector so as to be movable with respect to the base in the first direction and the direction intersecting the first direction.

3. The hand-driving movable body according to claim 1, wherein
the support portion includes an elastic member that generates an elastic force pushing the first connector in a direction opposite to the first direction.

4. The hand-driving movable body according to claim 3, wherein
the first connector includes a supported portion,
the supported portion is provided with a through hole penetrating the supported portion in the first direction,
the support portion includes:
two fixing portions separated from each other in the first direction;
a shaft extending in the first direction and inserted into the through hole, the shaft extending over the two fixing portions; and
the elastic member, and
the elastic member is interposed between the fixing portion on the first direction side of the two fixing portions and the supported portion.
